(19) United States
(12) Patent Application Publication
(10) Pub. No.: US 2026/0023218 A1
(43) Pub. Date: Jan. 22, 2026

(54) LOW POWER PHOTONIC RESONATORS

(71) Applicant: Mellanox Technologies, Ltd., Yokneam (IL)

(72) Inventors: Liron Gantz, Haifa (IL); Ori Eyal, Kerem Maharal (IL); Ziv Alperovich, Hararit (IL); Assaf David, Haifa (IL); Shai Cohen, Haifa (IL)

(21) Appl. No.: 18/776,367

(22) Filed: Jul. 18, 2024

(51) Int. Cl. G02B 6/293

(52) U.S. Cl. CPC G02B 6/29395; G02B 6/29338

(57) ABSTRACT

Embodiments described herein relate to locking a ring resonator to a fixed wavelength by using a power efficient algorithm. For example, a system can include a processing circuitry (e.g., a processing device or controller) configured to tune (e.g., calibrate) the photonic resonator (e.g., the ring waveguide) to a selected stable operation point at the vicinity of a resonance point.

### TECHNICAL FIELD

The present disclosure pertains to processing resources used to perform and facilitate high-speed communications. For example, at least one embodiment pertains to technology for low power photonic resonators.

### BACKGROUND

Communication systems transmit signals from a transmitter to a receiver via a communication channel or medium (e.g., cables, printed circuit boards, links, wirelessly, etc.) For example, the transmitter can use serial communication to transmit serial data within a serial data stream to the receiver via a serial communication channel (e.g., data sent sequentially on a per-bit basis over a single channel). As another example, the transmitter can use parallel communication to transmit parallel data within a parallel data stream to the receiver via the communication channel (i.e., multiple bits of data sent simultaneously via respective channels). Data can be encoded within a carrier wave or signal using a modulation technique. One example of a modulation technique is frequency modulation, which encodes data within a carrier signal by varying the frequency of the carrier signal. To do so, a modulator can combine the carrier signal with a data signal (i.e., baseband signal) to generate a modulated signal.

### General Description

### BRIEF DESCRIPTION OF DRAWINGS

Various embodiments in accordance with the present disclosure will be described with reference to the drawings, in which:

FIG. 1 is an example communication system, in accordance with at least some embodiments;

FIG. 2 illustrates an example system that can be used to tune photonic resonators to wavelengths of coherent light using ring waveguide self-heating, in accordance with at least some embodiments;

FIG. 3 illustrates an example ring modulator, in accordance with at least some embodiments;

FIG. 4 is a diagram illustrating a self-correction mechanism implemented by a tuned photonic resonator, in accordance with at least some embodiments;

FIG. 5 is a flow diagram of a method to tune photonic resonators to wavelengths of coherent light using ring waveguide self-heating, in accordance with at least some embodiments; and

FIG. 6 illustrates an example computer system including a transceiver including a chip-to-chip interconnect, in accordance with at least some embodiments.

### DETAILED DESCRIPTION

Embodiments described herein relate to low power photonic resonators. Optical links are communication links that use optical fibers to transmit optical signals (e.g., data signals or data streams) between two points. For example, an optical transmitter (“transmitter”) can receive optical signals generated by one or more optical signal generators, and the transmitter can transmit optical signals to an opto-electric receiver (“receiver”). In some implementations, an optical signal generator includes a laser. A transmitter can include a modulator that can encode data onto an optical carrier using modulation, and the transmitter can transmit modulated optical signals to a receiver. The receiver can include a photodetector to detect optical signals (e.g., modulated optical signals) received from the transmitter, and can convert the optical signals into electrical signals that can be processed by an electronic device. Optical links can be used to transmit large amounts of data over long distances with minimal signal loss. Optical links can be used in a variety of applications that can utilizes the transmission of optical signals, such as network adapters, switches, processing units (e.g., graphics processing units (GPUs), central processing units (CPUs), data processing units (DPUs), etc.

Various optical networking technologies can be used for transmitting multiple optical signals (e.g., data signals or data streams) over a single optical fiber within an optical link with little to no optical signal interference. Such optical networking technologies can increase the amount of data that can be transmitted via a single optical fiber, which can increase bandwidth efficiency and reduce the amount of infrastructure (e.g., hardware) needed for data communication.

One type of optical networking technology is time division multiplexing (TDM). In TDM, multiple optical signals (e.g., data signals or data streams) can be transmitted over a single optical fiber by assigning each optical signal a respective time slot, and transmitting an optical signal during its respective time slot. The time slots can be allocated to optical signals in a cyclic manner, in which each optical signal transmits a small amount of data during its assigned time slot. The time slots can be very short, such as on the order of microseconds, and the cycle is repeated many times per second to allow for rapid data transfer.

Another type of optical networking technology is frequency division multiplexing (FDM). In FDM, multiple optical signals (e.g., data signals or data streams) can be transmitted over a single optical fiber by assigning each optical signal a respective frequency band. More specifically, each optical signal can be modulated onto a respective carrier frequency to generate a respective modulated signal, and the modulated signals can be combined and transmitted by a receiver over a single optical fiber. At the receiver, the modulated signals can be separated using one or more filters (e.g., band-pass filters). More specifically, the one or more filters permit optical signals to pass through that meet one or more frequency specifications set by the one or more filters, while filtering out signals that do not meet the one or more frequency specifications. Accordingly, FDM can be used by optical links to simultaneously transmit multiple channels simultaneously over the same frequency band.

Yet another type of optical networking technology is wavelength division multiplexing (WDM). In WDM, multiple optical signals (e.g., data signals or data streams) having different wavelengths can be combined into a single optical signal and transmitted over a single optical fiber (e.g., simultaneous transmission of multiple wavelengths of light). More specifically, WDM techniques can generally involve combining and separating multiple optical signals having different wavelengths onto a single optical fiber. By doing so, WDM technology can allow for more data to be transmitted over an optical fiber and/or increase the capacity of the optical fiber.

Examples of WDM technology includes coarse wavelength division multiplexing (CWDM) and dense wavelength division multiplexing (DWDM). In CWDM, multiple optical signals (e.g., data signals or data streams) at different wavelengths are combined into a single optical signal and transmitted over a single optical fiber. The names CWDM and DWDM refer to the coarseness and denseness, respectively, of wavelength separation between wavelengths. More specifically, CWDM uses a coarser or wider wavelength separation than DWDM, which uses a denser or narrower wavelength separation. For example, wavelengths for CWDM can be separated by, e.g., about 80 nanometers (nm), while wavelengths for DWDM can be separated by, e.g., about 0.8 nm. The wider wavelength separation used in CWDM means that CWDM can support fewer channels and have lower power budgets than DWDM, and so CWDM can be used for shorter distances than DWDM, such as, e.g., up to about 80 kilometers (km). At the same time, CWDM uses less complex equipment and can use lower-cost optical components as compared to DWDM, which can make it a more cost-effective solution for applications that may not require denser wavelength separation.

One type of optical modulation scheme is a ring-based optical modulation scheme. A ring-based optical link is an optical link that integrates a ring modulator. A ring modulator is an optical component that can be used to modulate coherent optical carrier (e.g., coherent light) having a fixed wavelength. A ring modulator can include set of waveguides in which at least one waveguide is in the form of a closed loop (“ring waveguide”) disposed between one or more bus waveguides. The ring waveguide can support one or more resonant wavelengths (or frequencies) in which photons having constructive or destructive interference with the photons coming from the bus waveguide. Thus, when the optical carrier in the bus is at the vicinity of resonant wavelength, field enhancement occurs in the ring waveguide due to constructive (or destructive) interference, resulting in high optical intensity. Since only a portion of the wavelengths of the optical carrier will be at resonance within the ring waveguide, the ring waveguide can function as an optical filter. Ring waveguides exploit phenomena such as total internal reflection and optical coupling, which can depend on the index of refraction of the material of the ring waveguide (e.g., silicon). In some implementations, a ring modulator is a micro-ring modulator (MRM).

The resonant wavelength(s) of a ring waveguide may not be known ahead of time. Additionally, components of ring modulators (e.g., ring waveguides) can suffer from variations in manufacturing. To address these situations, the ring waveguide resonance wavelength can be tuned to match the carrier wavelength generated by a coherent light generator.

Some solutions for tuning a ring waveguide resonance to match an optical carrier is by utilizing a heater that heats the ring waveguide thus red shifting its resonance (e.g., constant). Using a heater to maintain a ring waveguide at some temperature can generate reliability problems, and consumes power by constantly stabilizing a working point of the ring waveguide using processing circuitry. For example, processing circuitry can implement electrical control loops to maintain the ring waveguide at its working point.

Aspects of the present disclosure can address the deficiencies above and other challenges by tuning photonic resonators to wavelengths of coherent light using self-heating. This technique a ring resonator to be locked to a fixed wavelength by using a power-efficient algorithm. In some embodiments, a photonic resonator includes ring modulator have a ring waveguide. The system can further include a photodetector to monitor spectral shift of the waveguide ring, and processing circuitry (e.g., a processing device or controller) can tune (e.g., calibrate) the photonic resonator (e.g., the ring waveguide) to a selected stable operation point at the vicinity of a resonance point. The stable operation point can be defined as an optimal insertion loss point (e.g., a spectral point in which a high speed signal is applied to achieve an approximately linear response). In some embodiments, the stable operation point is approximately 6 decibels (dB).

Upon tuning the photonic resonator (e.g., ring waveguide) to the stable operation point, the processing circuitry can disable the heater. That is, the processing circuitry can cause the heater to shut down or turn off. The system will stabilize at the stable operation point according to a self-correction phenomenon (e.g., the laser wavelength will be locked inside the resonance). The self-correction phenomenon is a “natural” feedback response to deviations from the stable operation point. In some embodiments, the processing circuitry automatically disables the heater in response to reaching the stable operation point. In some embodiments, the heater is manually disabled.

The self-correction phenomenon can be a result of a balance between self-heating of the photonic resonator and self-cooling of the photonic resonator. For example, when coherent light field enhancement occurs in a ring waveguide, self-heating occurs due to the energy inside the ring waveguide. The energy inside of the ring waveguide generates heat and increases the temperature of the ring waveguide. This causes a change to the index of refraction of the material of the ring waveguide and a corresponding leftward shift (i.e. red shift) of the resonant wavelength of the ring waveguide (e.g., a new resonant wavelength shorter than the previous resonant wavelength). The red shift of the resonant wavelength reduces the field enhancement the ring waveguide, which decreases the energy generated inside of the ring waveguide and therefore decreases the temperature of the ring waveguide. This causes an opposite change to the index refraction of the material of the ring waveguide and a corresponding rightward shift of the resonant wavelength of the ring waveguide. At some point, the resonant wavelength will shift to the stable operation point, in which the temperature increase (due to heat generated by the ring waveguide absorbing the light) is balanced out by an approximately equal temperature decrease. A similar self-correction phenomenon can result from a change of the wavelength of the coherent light (e.g., due to temperature changes in the coherent light generator).

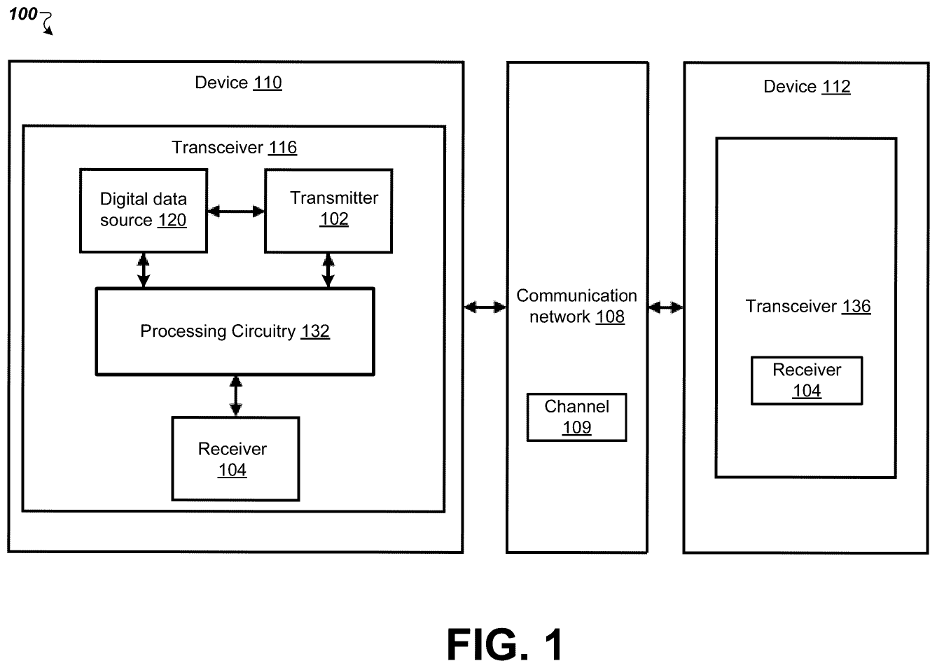

Embodiments described herein can be used to track changes in ring temperature, ambient temperature, and wavelength. No control loops or heaters are needed to maintain a ring waveguide at a stable operation point after the heater is disabled. Since the ring modulator will be stable, processing circuitry need not be used to maintain the ring waveguide at a high temperature. Further details regarding tuning ring modulators to wavelengths of coherent light using ring waveguide self-heating will be described below with reference to FIGS. 1-6.

Advantages of the present disclosure include, for example, reduced power consumption and increased reliability. For example, the self-correction mechanism described herein can obviate the need for a heater to maintain a photonic resonator (e.g., ring waveguide) at a high temperature.

FIG. 1 illustrates an example communication system 100 according to at least one example embodiment. The system 100 includes a device 110, a communication network 108 including a communication channel 109, and a device 112. In at least one embodiment, devices 110 and 112 are two end-point devices in a computing system, such as a central processing unit (CPU) or graphics processing unit (GPU). In at least one embodiment, devices 110 and 112 are two servers. In at least one example embodiment, devices 110 and 112 correspond to one or more of a Personal Computer (PC), a laptop, a tablet, a smartphone, a server, a collection of servers, or the like. In some embodiments, the devices 110 and 112 may correspond to any appropriate type of device that communicates with other devices connected to a common type of communication network 108. According to embodiments, the receiver 104 of devices 110 or 112 may correspond to a GPU, a switch (e.g., a high-speed network switch), a network adapter, a CPU, a memory device, an input/output (I/O) device, other peripheral devices or components on a system-on-chip (SoC), or other devices and components at which a signal is received or measured, etc. As another specific but non-limiting example, the devices 110 and 112 may correspond to servers offering information resources, services, and/or applications to user devices, client devices, or other hosts in the system 100. In one example, devices 110 and 112 may correspond to network devices such as switches, network adapters, or data processing units (DPUs).

Examples of the communication network 108 that may be used to connect the devices 110 and 112 include an Internet Protocol (IP) network, an Ethernet network, an InfiniBand (IB) network, a Fibre Channel network, the Internet, a cellular communication network, a wireless communication network, a ground referenced signaling (GRS) link, combinations thereof (e.g., Fibre Channel over Ethernet), variants thereof, and/or the like. In one specific but non-limiting example, the communication network 108 is a network that enables data transmission between the devices 110 and 112 using data signals (e.g., digital, optical, wireless signals).

The device 110 includes a transceiver 116 for sending and receiving signals, for example, data signals. The data signals may be digital or optical signals modulated with data or other suitable signals for carrying data.

The transceiver 116 may include a digital data source 120, a transmitter 102, a receiver 104, and processing circuitry 132 that controls the transceiver 116. The digital data source 120 may include suitable hardware and/or software for outputting data in a digital format (e.g., in binary code and/or thermometer code). The digital data output by the digital data source 120 may be retrieved from memory (not illustrated) or generated according to input (e.g., user input).

The transmitter 124 includes suitable software and/or hardware for receiving digital data from the digital data source 120 and outputting data signals according to the digital data for transmission over the communication network 108 to a receiver 104 of device 112. Additional details of the structure of the transmitter 124 are discussed in more detail below with reference to the figures.

The receiver 104 of devices 110 and 112 may include suitable hardware and/or software for receiving signals, such as data signals from the communication network 108. For example, the receiver 104 may include components for receiving optical signals.

The processing circuitry 132 may comprise software, hardware, or a combination thereof. For example, the processing circuitry 132 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 132 may comprise hardware, such as an application-specific integrated circuit (ASIC). Other non-limiting examples of the processing circuitry 132 include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry 132 may be provided on a Printed Circuit Board (PCB) or collection of PCBs. It should be appreciated that any appropriate type of electrical component or collection of electrical components may be suitable for inclusion in the processing circuitry 132. The processing circuitry 132 may send and/or receive signals to and/or from other elements of the transceiver 116 to control the overall operation of the transceiver 116.

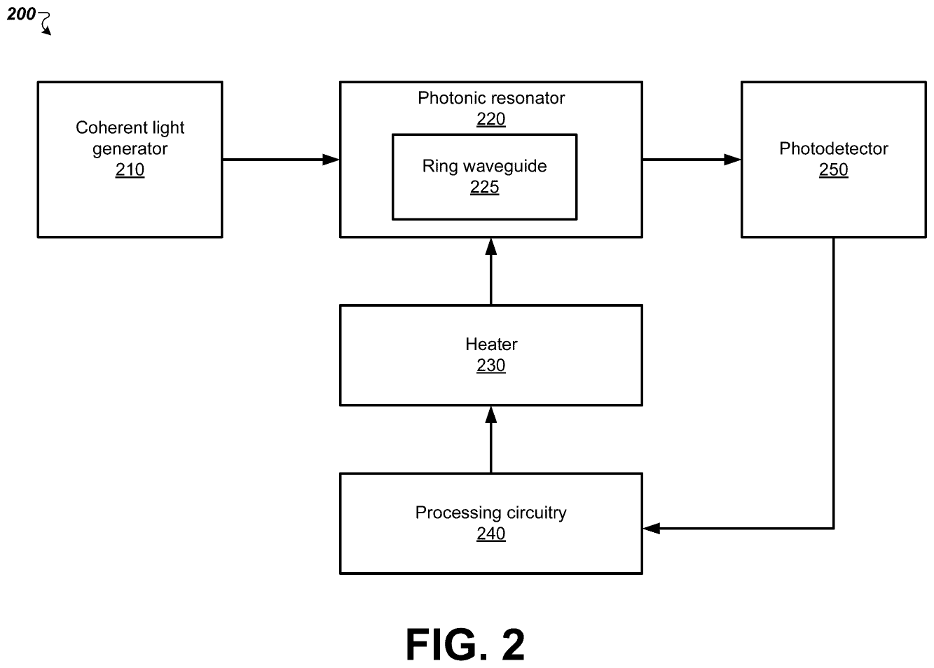

In some examples, the processing circuitry 132 can facilitate a method to tune ring modulators to wavelengths of coherent light using ring waveguide self-heating. For example, the processing circuitry 132 can cause a heater to tune a ring waveguide of a ring modulator to a stable operation point and, upon tuning the ring waveguide to the stable operation point, disable the heater to cool the ring waveguide, as described with reference to FIGS. 2-5.

The transceiver 116 or selected elements of the transceiver 116 may take the form of a pluggable card or controller for the device 110. For example, the transceiver 116 or selected elements of the transceiver 116 may be implemented on a network interface card (NIC).

The device 112 may include a transceiver 136 for sending and receiving signals, for example, data signals over a channel 109 of the communication network 108. The same or similar structure of the transceiver 116 may be applied to transceiver 136, and thus, the structure of transceiver 136 is not described separately.

Although not explicitly shown, it should be appreciated that devices 110 and 112 and the transceivers 116 and 120 may include other processing devices, storage devices, and/or communication interfaces generally associated with computing tasks, such as sending and receiving data.

FIG. 2 illustrates an example system 200 that can be used to tune photonic resonators to wavelengths of coherent light using ring waveguide self-heating, in accordance with at least some embodiments. As shown, the system 200 includes a coherent light generator 210. The coherent light generator 210 is configured to generate one or more light wavelengths. In some embodiments, the light generator 210 includes a laser.

The system 200 can further include a photonic resonator 220 including a ring waveguide 225 to receive coherent light having the wavelength from the coherent light generator 210. In some embodiments, the photonic resonator 220 is a micro-ring modulator. In some embodiments, the photonic resonator 220 is implemented in an optical receiver. In some embodiments, the photonic resonator 220 is implemented in an optical transmitter. The system can further include a heater 230. Heater 230 may include one or more heating elements. Additionally or alternatively, heater 230 may include one or more resistors coupled to a ground potential, and a temperature control signal is a voltage supplied to the one or more resistors. In this manner, the amount of heat emitted by the resistor(s) may be decreased or increased based on a corresponding decrease or increase of voltage to the resistor(s).

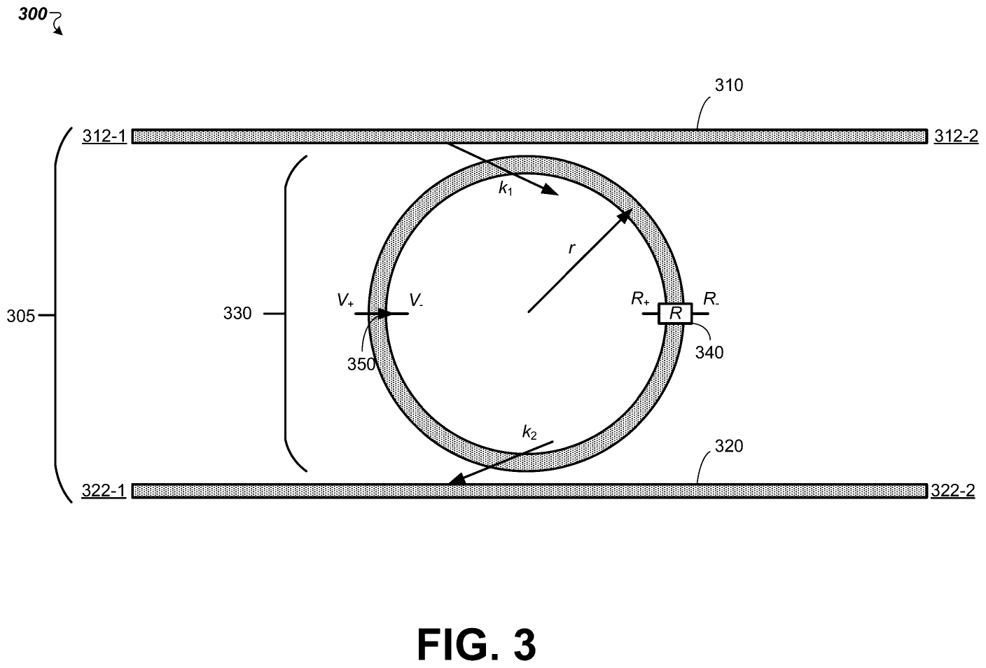

For example, the heater 230 can be operatively coupled to the ring waveguide 225. An example implementation of the photonic resonator 220 and the heater 230 will be described below with reference to FIG. 3.

The system 200 can further include processing circuitry 240. For example, the processing circuitry 240 can be implemented within a processing device or controller. The processing circuitry 240 can enable (e.g., turn on) the heater 230 to tune the photonic resonator 220 (e.g., the ring waveguide 225). In some embodiments, the processing circuitry 240 identifies a voltage to apply to the heater 230, where the voltage corresponds to a temperature used to tune the ring waveguide 225 to the stable operation point. In some embodiments, the processing circuitry 240 causes the heater to tune the ring waveguide to the stable operation point by causing the voltage to be applied to the heater to tune the ring waveguide to the stable operation point.

The system 200 can further include a photodetector 250 to monitor the spectral shift of the photonic resonator 220. The photodetector can be connected to the processing circuitry 240, which can control the operation of the heater 230 in accordance with the monitor reading.

The processing circuitry 240 can disable the heater 230 upon determining that the photonic resonator 220 (e.g., the ring waveguide) 225 is tuned to a stable operation point. For example, the processing circuitry 240 can determine that the photonic resonator 220 is tuned to the stable operation point from the spectral shift monitored by the photodetector 250. In some embodiments, stable operation point is approximately 6 dB.

The photonic resonator 220 (e.g., ring waveguide 225) can use a self-correction mechanism that achieves stability about the stable operation point. For example, absorption of coherent light by the photonic resonator 220 results in self-heating of the photonic resonator 220 (i.e., without use of the heater 230). The rise in temperature of the photonic resonator 220 caused by the absorption of coherent light causes a shift in resonant wavelength in a first direction (e.g., left direction). The shift in resonant wavelength in the first direction causes a reduction in an amount of coherent light absorbed by the photonic resonator 220. The reduction in the amount of coherent light absorbed by the photonic resonator 220 results in a cooling of the photonic resonator that causes a shift in resonant wavelength in a second direction opposite the first direction (e.g., right direction) until the stable operation point is reached. Thus, a first shift in resonant wavelength in a first direction away from the stable operation point causes a reduction in coherent light absorbed by the photonic resonator 220, and the reduction in the coherent light absorbed by the photonic resonator 220 causes a second shift in resonant wavelength in a second direction opposite the first direction to return to the stable operation point. Accordingly, after disabling the heater 230, the photonic resonator 220 can operate about the stable operation point based on self-heating of the photonic resonator 220 without external heating and self-cooling of the photonic resonator 220.

FIG. 3 illustrates an example system including a ring modulator 305, according to at least one example embodiment. For example, the ring modulator 305 can be similar to photonic resonator 220, as described above with reference to FIG. 2. For example, the ring modulator 305 can include a pair of bus waveguides 310 and 320. For example, the bus waveguide 310 can be a through bus waveguide and the bus waveguide 320 can be a drop bus waveguide. In some embodiments, and as shown in this illustrative example, the bus waveguides 310 and 320 are linear (e.g., horizontal) waveguides. However, the bus waveguides 310 and 320 can have any suitable shape in accordance with embodiments described herein.

The bus waveguides 310 and 320 can have respective ports, which can be used to address and probe the behavior of the ring modulator 305. As shown in this illustrative example, the bus waveguide 210 can have ports 312-1 and 312-2, and the bus waveguide 320 can have ports 322-1 and 322-2. For example, port 312-1 can be referred to as an input port, port 312-2 can be referred to as a through port, port 322-1 can be referred to as a drop port and port 322-2 can be referred to as an add port. Accordingly, in this illustrative example, the ring modulator 305 can be a four-port ring modulator.

The ring modulator 305 further includes a ring waveguide 330 (e.g., similar to ring waveguide 225 of FIG. 2) disposed between the bus waveguides 310 and 320. The ring waveguide 330 is a closed-loop structure. The arrow “r” denotes the radius of the ring waveguide 330, as measured as the distance from the center of the ring to the center of the ring waveguide 330. The radius of the ring waveguide 330 can be on the order of micrometers or microns (μm) in some embodiments. In some embodiments, the radius of the ring waveguide 330 is between about 1 μm to about 10 μm.

The ring modulator ring modulator 305 is configured to receive at least one wavelength of radiation generated by a wavelength generator (e.g., the coherent light generator 210 of FIG. 2). In some embodiments, the at least one wavelength of radiation includes multiple wavelengths of radiation. For example, a tunable optical wave (e.g., laser light) having a number of wavelengths of radiation can be received in the port 312-1. The ring waveguide 330 can be tuned to a resonant wavelength (2) such that photons having the resonant wavelength are coupled to the ring waveguide 330 and re-routed to the port 322-1, while photons not having the resonant wavelength pass through toward the port 312-2. Accordingly, the ring waveguide 330 can function as a spectral filter.

Illustratively, assume that a first photon having the resonant wavelength is received by the port 312-1. As this photon travels left to right, the first photon enters the ring waveguide 330 via optical coupling. If a second photon having the resonant wavelength is received by the port 312-1, the subsequent photon adds coherently (in phase and polarization and frequency) with the first photon that is already in the ring waveguide 230. This initiates a process referred to as field enhancement, in which photons having the resonant wavelength continue to build up within the ring waveguide 330. Arrow “k₁” denotes a first coupling coefficient corresponding to an amount of optical power coupled to the ring waveguide 330 from the bus waveguide 310 (e.g., percentage).

The waveguides 310-330 can be formed from any suitable material that has properties (e.g., index of refraction) to enable the optical coupling of light having the resonant wavelength within the ring waveguide 330. In some embodiments, the waveguides 310-330 are formed from a semiconductor material. For example, the waveguides 310-330 can be formed from silicon (Si). Alternatively, at least one of the waveguides 310-330 can be formed from a different material.

The field enhancement process described above cannot occur indefinitely. At a certain electrical field or optical power level, the number of photons having the resonant wavelength within the ring waveguide 330 can reach a saturation threshold and begin to radiate or couple out of the ring waveguide 330. Arrow “k₂” denotes a second coupling coefficient corresponding to an amount of optical power coupled from the ring waveguide 330 to the bus waveguide 320 (e.g., percentage).

The optical power level can be correlated with a quality factor of the ring modulator 305, Q. The quality factor Q is a dimensionless quantity that serves as a metric of “sharpness” of resonance or filtering achieved by the ring waveguide 330. The quality factor Q can be used to determine the average number of round-trip turns or cycles that a photon can make before leaving the ring waveguide 330 and entering the bus waveguide 320. For example, the quality factor Q can be directly (e.g., linearly) related to average photon lifetime, which is the average time that a photo will spend in the ring waveguide 330 before exiting. Accordingly, the higher the quality factor Q, the greater the average photon lifetime and number of round-trip turns. The quality factor Q can be inversely proportional to a full width at half maximum (FWHM) value of the transmission spectra observed to exit through the port 312-2. For example, Q=λ₀/FWHM. Here, the FWHM is the difference or distance between two wavelength values, observed at the port 312-2, having an optical power level determined to be equal to half of a maximum optical power value. For example, the optical power level can be modeled as a transfer function (e.g., Lorentzian). Accordingly, a greater FWHM value translates into a lower Q value.

At least one electrical component can be operatively coupled (e.g., integrated into) the ring waveguide 330 as a heater to tune the ring waveguide 330. For example, applying a voltage (e.g., bias) to the at least one electrical component can cause a modification to at least the index of refraction of the ring waveguide 330, which can tune the quality factor Q and thus tune the ring waveguide 330. The at least one electrical component can include any suitable electronic component(s) in accordance with embodiments described herein. In some embodiments, the at least one electrical component can include at least one of a diode, a resistor, or a transistor (e.g., field-effect transistor (FET)).

As shown, the at least one electrical component can include a diode 340. In some embodiments, the diode 340 is a P-N diode including a P-N junction between P-type semiconductor material and N-type semiconductor material. In some embodiments, the diode 340 is a P-I-N diode, in which intrinsic semiconductor material (I) is disposed between P-type and N-type semiconductor material. In some embodiments, the diode 340 can function as a delay adder. For example, when the diode 240 is in an off state (i.e., turned off), the ring modulator 305 can have an initial quality factor Q (Q₀), an initial FWHM (FWHM₀) and an initial average photon lifetime τ (τ₀). When processing circuitry causes an amount of positive voltage to be applied to the diode 340, the diode 340 can generate a corresponding number of charge carriers for injection into the ring waveguide 330. These charge carriers can modify the index of refraction of the ring waveguide 330 in a manner that increases the FWHM from the FHWM₀ to a new FHWM (FHWM₁). For example, a relationship can exist between charge carrier density and the index of refraction. The effect can be diminished as the positive voltage exceeds the threshold voltage for the diode. Since FHWM is inversely proportional to the quality factor Q, the FHWM₁ corresponds to a new quality factor Q (Q₁) that is less than Q₀. The decrease in the quality factor from Q₀ to Q₁ corresponds to a decrease in the average photon lifetime τ from τ₀ to a new average photon lifetime τ (τ₁). In this manner, the diode 340 behaves as a delay modification tool. Additionally or alternatively, in some embodiments, the diode 340 can function as a delay remover. For example, if the diode 340 is a P-N diode, then an amount of negative voltage applied to the diode 340 can expand the depletion region between the P-type semiconductor material and the N-type semiconductor material. This can cause removal of charge carriers from ring waveguide 330.

Additionally or alternatively, the at least one electrical component can include a resistor (e.g., resistive heater) 350. For example, when processing circuitry causes an amount of voltage to be applied to the resistor 350, the resistor 350 can tune the local temperature which tunes the on-resonance wavelength for the ring waveguide 330.

The diode 340 and the resistor 350 can tune the ring waveguide 330 with different amounts of granularity. For example, the diode 340 can be a fine-delay component and the resistor 350 can be a coarse-delay component. Moreover, multiple diodes, resistors, transistors, etc. that have respective sensitivities can be coupled to the ring waveguide 330. Accordingly, in some embodiments, the at least one electrical component can include multiple electrical components to tune the at least one ring modulator more accurately.

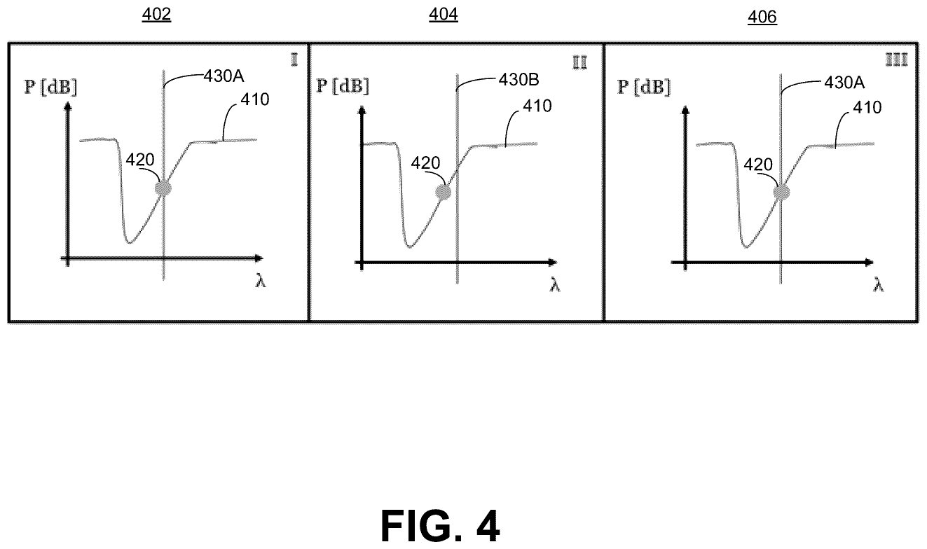

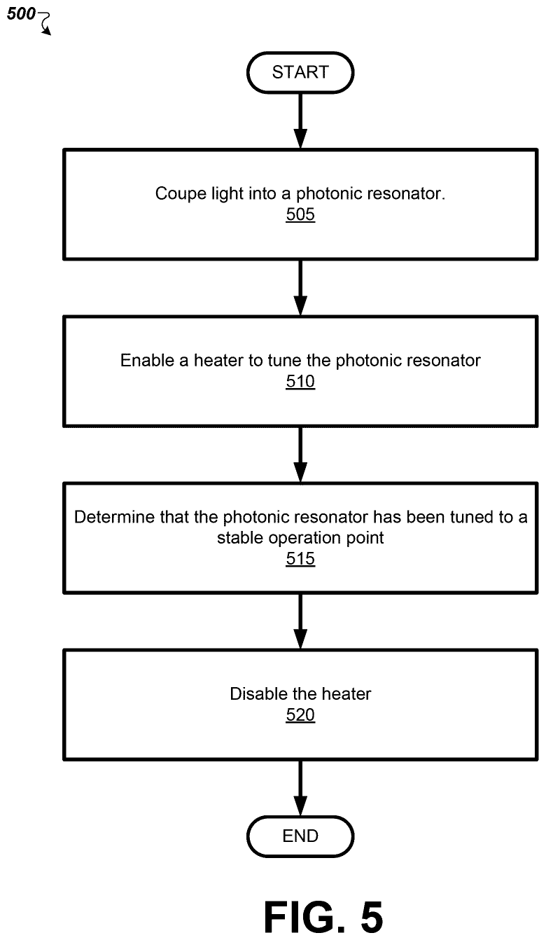

FIG. 4 are graphs 402-406 illustrating a self-correction mechanism implemented by a tuned ring waveguide, in accordance with at least some embodiments. Each of graphs 402-406 has an x-axis corresponding to wavelength (λ) and a y-axis corresponding to power (e.g., in dB). For example, graph 402 showing a system in a stable state. More specifically, graph 400A shows ring waveguide spectral shape 410, stable operation point 420, and line 430A corresponding to a fixed wavelength of coherent light. Graph 404 shows a momentary shift in ring waveguide temperature or wavelength. For example, if the temperature increases, then the resonance shifts to the left direction and less coherent light is absorbed by the ring waveguide. This causes the ring waveguide to cool, which shifts the resonance in the right direction. Graph 406 shows a return of the system to the stable operation point 420 after the cooling. Further details regarding FIG. 4 are described above with reference to FIGS. 1-3 and will now be described below with reference to FIG. 5.

FIG. 5 illustrates a flow diagram of a method 500 to tune ring modulators to wavelengths of coherent light using ring waveguide self-heating, according to at least some embodiments. The method 500 can be performed by processing logic comprising hardware, software, firmware, or any combination thereof. In at least one embodiment, the method 500 is performed by processing circuitry, such as processing circuitry 132 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, processing logic couples light into a photonic resonator. For example, processing logic can cause coherent light to be coupled into the photonic resonator. For example, the photonic resonator can include a ring waveguide. The light can be generated by a light source. The ring waveguide can be included in a ring modulator. In some embodiments, the ring waveguide is included in a micro-ring modulator. In some embodiments, the light has a fixed wavelength.

At operation 510, processing logic enables a heater to tune the photonic resonator. In some embodiments, enabling the heater includes causing a voltage to be applied to the heater to tune the ring waveguide to a resonant wavelength. The heater, when enabled, can cause a spectral shift with respect to the photonic resonator. In some embodiments, causing the heater to tune the ring waveguide to the stable operation point includes identifying a voltage to apply to the heater, where the voltage corresponds to the temperature used to tune the ring waveguide to the resonant wavelength.

At operation 515, processing logic determines that the photonic resonator has been tuned to a stable operation point. For example, determining that the photonic resonator has been tuned to the stable operation point can include using a photodetector to monitor the spectral shift caused by the heater, and detecting that the photonic resonator has been tuned to the stable operation point based on the spectral shift. The stable operation point can a point set near the resonant wavelength. In some embodiments, the stable operation point is approximately 6 dB.

At operation 520, processing logic disables the heater responsive to determining that the stable operation point has been reached. In some embodiments, the processing logic automatically disables the heater in response to reaching the stable operation point. In some embodiments, the heater is manually disabled.

The photonic resonator (e.g., ring waveguide) can use a self-correction mechanism that achieves stability about the stable operation point. For example, absorption of light by the photonic resonator results in self-heating of the photonic resonator (i.e., without use of the heater). The rise in temperature of the photonic resonator caused by the absorption of the light can cause a shift in resonant wavelength in a first direction (e.g., left direction). The shift in resonant wavelength in the first direction can cause a reduction in an amount of light absorbed by the photonic resonator. The reduction in the amount of light absorbed by the photonic resonator results in a cooling of the photonic resonator that causes a shift in resonant wavelength in a second direction opposite the first direction (e.g., right direction) until the stable operation point is reached. Thus, a first shift in resonant wavelength in a first direction away from the stable operation point causes a reduction in light absorbed by the photonic resonator, and the reduction in light absorbed by the photonic resonator causes a second shift in resonant wavelength in a second direction opposite the first direction to return to the stable operation point. Accordingly, after disabling the heater, the photonic resonator can operate about the stable operation point based on self-heating of the photonic resonator without external heating and self-cooling of the photonic resonator. Further details regarding operations 505-520 are described above with reference to FIGS. 2-4.

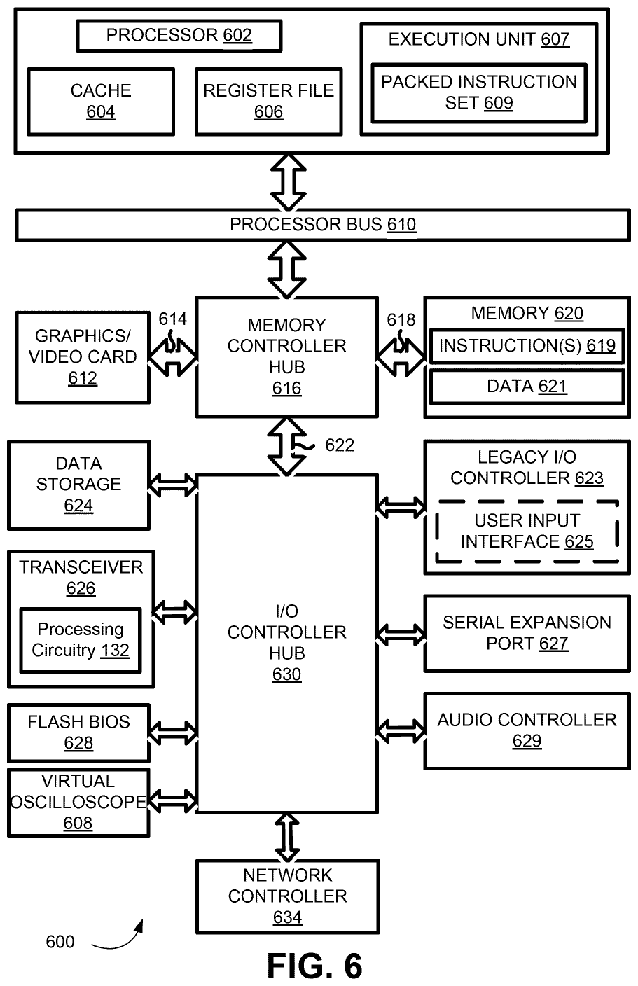

FIG. 6 illustrates a computer system 600 including a transceiver including a chip-to-chip interconnect, in accordance with at least one embodiment. In at least one embodiment, computer system 600 may be a system with interconnected devices and components, an SOC, or some combination. In at least one embodiment, computer system 600 is formed with a processor 602 that may include execution units to execute an instruction. In at least one embodiment, computer system 600 may include, without limitation, a component, such as processor 602 to employ execution units including logic to perform algorithms for processing data. In at least one embodiment, computer system 600 may include processors, such as PENTIUM® Processor family, Xcon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 600 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 600 may be used in devices such as graphics processing units (GPUs), network adapters, central processing units and network devices such as switch (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 600 may include, without limitation, processor 602 that may include, without limitation, one or more execution units 607 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 600 is a single processor desktop or server system. In at least one embodiment, computer system 600 may be a multiprocessor system. In at least one embodiment, processor 602 may include, without limitation, a CISC microprocessor, a RISC microprocessor, a VLIW microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. In at least one embodiment, processor 602 may also include a combination of both internal and external caches. In at least one embodiment, a register file 606 may store different types of data in various registers including, without limitation, integer registers, floating point registers, status registers, and instruction pointer register.

In at least one embodiment, execution unit 607, including, without limitation, logic to perform integer and floating point operations, also resides in processor 602. Processor 602 may also include a microcode (“ucode”) read only memory (“ROM”) that stores microcode for certain macro instructions. In at least one embodiment, execution unit 602 may include logic to handle a packed instruction set 609. In at least one embodiment, by including packed instruction set 609 in an instruction set of a general-purpose processor 602, along with associated circuitry to execute instructions, operations used by many multimedia applications may be performed using packed data in a general-purpose processor 602. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, an execution unit may also be used in microcontrollers, embedded processors, graphics devices, DSPs, and other types of logic circuits. In at least one embodiment, computer system 600 may include, without limitation, a memory 620. In at least one embodiment, memory 620 may be implemented as a DRAM device, an SRAM device, flash memory device, or other memory device. Memory 620 may store instruction(s) 619 and/or data 621 represented by data signals that may be executed by processor 602.

In at least one embodiment, a system logic chip may be coupled to processor bus 610 and memory 620. In at least one embodiment, the system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data and textures. In at least one embodiment, MCH 616 may direct data signals between processor 602, memory 620, and other components in computer system 700 and to bridge data signals between processor bus 610, memory 620, and a system I/O 622. In at least one embodiment, system logic chip may provide a graphics port for coupling to a graphics controller. In at least one embodiment, MCH 616 may be coupled to memory 620 through high bandwidth memory path 618 and graphics/video card 612 may be coupled to MCH 616 through an Accelerated Graphics Port (“AGP”) interconnect 614.

In at least one embodiment, computer system 600 may use system I/O 622 that is a proprietary hub interface bus to couple MCH 616 to I/O controller hub (“ICH”) 630. In at least one embodiment, ICH 630 may provide direct connections to some I/O devices via a local I/O bus. In at least one embodiment, local I/O bus may include, without limitation, a high-speed I/O bus for connecting peripherals to memory 620, a chipset, and processor 602. Examples may include, without limitation, an audio controller 629, a firmware hub (“flash BIOS”) 628, a transceiver 626, a data storage 624, a legacy I/O controller 623 containing a user input interface 625 and a keyboard interface, a serial expansion port 627, such as a USB, and a network controller 634. Data storage 624 may comprise a hard disk drive, a floppy disk drive, a CD-ROM device, a flash memory device, or other mass storage device. In an embodiment, the transceiver 626 includes a constrained FFE 608.

In at least one embodiment, FIG. 6 illustrates a system, which includes interconnected hardware devices or “chips” in the transceiver 626—e.g., the transceiver 626 includes a chip-to-chip interconnect including the first device 110 and second device 112 as described with reference to FIG. 1). In at least one embodiment, FIG. 6 may illustrate an exemplary SoC. In at least one embodiment, devices illustrated in FIG. 6 may be interconnected with proprietary interconnects, standardized interconnects (e.g., PCIe), or some combination thereof. In at least one embodiment, one or more components of system 600 are interconnected using compute express link (“CXL”) interconnects. In an embodiment, the transceiver 626 can include processing circuitry 132 as described with reference to FIG. 1. In such embodiments, the processing circuitry 132 can facilitate a method to tune ring modulators to wavelengths of coherent light using ring waveguide self-heating, such as that described above with reference to FIGS. 2-5.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work overtime, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a memory; and
a processing device, operatively coupled with the memory, to:
cause coherent light to be coupled into a photonic resonator comprising a ring waveguide;
enable a heater to tune the photonic resonator;
determine that the photonic resonator has been tuned to a stable operation point corresponding to a resonant wavelength; and
responsive to determining that the photonic resonator has been tuned to the stable operation point, disable the heater, wherein, after disabling the heater, the photonic resonator is to operate about the stable operation point based on self-heating of the ring waveguide without external heating.

2. The system of claim 1, wherein the processing device is further to identify a voltage to apply to the heater to enable the heater, and wherein the voltage corresponds to a temperature.

3. The system of claim 2, wherein, to enable the heater to tune the photonic resonator, the processing device is further to cause the voltage to be applied to the heater.

4. The system of claim 1, wherein, to determine that the photonic resonator has been tuned to the stable operation point, the processing device is further to monitor spectral shift using a photodetector.

5. The system of claim 1, wherein the stable operation point is approximately 6 decibels (dB).

6. The system of claim 1, wherein a first shift in resonant wavelength in a first direction away from the stable operation point causes a reduction in the coherent light absorbed by the ring waveguide, and wherein the reduction in the coherent light absorbed by the ring waveguide causes a second shift in resonant wavelength in a second direction opposite the first direction to return to the stable operation point.

7. The system of claim 1, wherein the ring waveguide is comprised in a micro-ring modulator.

8. A system comprising:
a coherent light source;
a photonic resonator comprising a ring waveguide;
a heater operatively coupled to the photonic resonator;
a photodetector; and
at least one processing device, operatively coupled to a memory, to:
cause coherent light generated by the coherent light source to be coupled into a photonic resonator comprising a ring waveguide;
enable the heater to tune the photonic resonator;
determine that the photonic resonator has been tuned to a stable operation point corresponding to a resonant wavelength; and
responsive to determining that the photonic resonator has been tuned to the stable operation point, disable the heater, wherein, after disabling the heater, the photonic resonator is to operate about the stable operation point based on self-heating of the ring waveguide without external heating.

9. The system of claim 8, wherein the processing device is further to identify a voltage to apply to the heater to enable the heater, and wherein the voltage corresponds to a temperature.

10. The system of claim 9, wherein, to enable the heater to tune the photonic resonator, the processing device is further to cause the voltage to be applied to the heater.

11. The system of claim 8, wherein, to determine that the photonic resonator has been tuned to the stable operation point, the processing device is further to monitor spectral shift using the photodetector.

12. The system of claim 8, wherein the stable operation point is approximately 6 decibels (dB).

13. The system of claim 8, wherein a first shift in resonant wavelength in a first direction away from the stable operation point causes a reduction in coherent light absorbed by the ring waveguide, and wherein the reduction in the coherent light absorbed by the ring waveguide causes a second shift in resonant wavelength in a second direction opposite the first direction to return to the stable operation point.

14. The system of claim 8, wherein the ring waveguide is comprised in a micro-ring modulator.

15. A method, comprising:
causing coherent light to be coupled into a photonic resonator comprising a ring waveguide;
enabling a heater to tune the photonic resonator;
determining that the photonic resonator has been tuned to a stable operation point corresponding to a resonant wavelength; and
responsive to determining that the photonic resonator has been tuned to the stable operation point, disabling the heater, wherein, after disabling the heater, the photonic resonator is to operate about the stable operation point based on self-heating of the ring waveguide without external heating.

16. The method of claim 15, further comprising identifying a voltage to apply to the heater to enable the heater, wherein the voltage corresponds to the temperature.

17. The method of claim 16, wherein enabling the heater to tune the photonic resonator comprises causes the voltage to be applied to the heater.

18. The method of claim 15, wherein determining that the photonic resonator has been tuned to the stable operation point comprises monitoring spectral shift using a photodetector.

19. The method of claim 15, wherein the stable operation point is approximately 6 decibels (dB).

20. The method of claim 15, wherein a first shift in resonant wavelength in a first direction away from the stable operation point causes a reduction in coherent light absorbed by the ring waveguide, and wherein the reduction in the coherent light absorbed by the ring waveguide causes a second shift in resonant wavelength in a second direction opposite the first direction to return to the stable operation point.
